(19) United States
(12) Patent Application Publication
(10) Pub. No.: US 2010/0066102 A1
(43) Pub. Date: Mar. 18, 2010

(54) Adjustable Sliding Device for Panic Exit Door Lock

(76) Inventor: Chun-Meng Shen, Sinying City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/211,879

(22) Filed: Sep. 17, 2008

(51) Int. Cl. E05B 65/10

(52) U.S. Cl. 292/92

(57) ABSTRACT

A lock for a door includes a latch to which an end of a connecting device is operably coupled, so that movement of the connecting device in a vertical direction causes movement of the latch between locking and unlocking positions. A base is fixed to the door, and a slide is slideably mounted to the base along the vertical direction. An adjusting block is coupled to the other end of the connecting device to move therewith. An adjusting screw is rotatably extended through the slide and threadedly coupled to the adjusting block so that movement of the slide in the vertical direction causes movement of the adjusting block and the connecting device in the vertical direction. Rotation of the adjusting screw causes movement of the adjusting block and the connecting device in the vertical direction to adjust the locking position of the latch relative to the door.

### BACKGROUND OF THE INVENTION

The present invention relates to a sliding device a panic exit door lock and, more particularly, to an adjustable sliding device for a top or bottom latch for a panic exit door lock that allows adjustment of extended extent of the top or bottom latch beyond a top face or a bottom face of the panic exit door to allow easy mounting of the lock.

Locks for panic exit doors include horizontal type latches and vertical type latches. Vertical type latches include a top latch and a bottom latch, wherein the top and bottom latches include concealed type and surfaced type according to the way they are mounted. Surfaced type latches are easy to install but can not provide an aesthetically pleasing appearance. Concealed type latches provide an aesthetically pleasing appearance at the cost of difficulties in installation.

A typical vertical latch type lock for a panic exit door generally includes top and bottom latches, a follower device, and a press bar that is operably coupled to the follower device and that can be pressed to unlatch the latches. The exposed extents of the latches after installation may be too large or too small and, thus, adversely affect operation of the latches. In an approach to solve this problem, each latch is coupled to a screw rod that is connected by a connecting rod to the follower device. The connecting rod is rotatable to adjust a coupling length between the screw rod and the connecting rod, which, in turn, changes the exposed extent of the latch. However, such adjustment must be accomplished before coupling of the connecting rod with the follower device. Specifically, if the improper exposed extents of the latches are found after installation, adjustment can only be carried out after removal of a housing enclosing the follower device and after disengaging an end of the connecting from the follower device.

Thus, a need exists for an adjusting device for a top or bottom latch for a panic exit door lock that allows adjustment of extended extent of the top or bottom latch beyond a top face or a bottom face of the panic exit door to allow easy mounting of the lock.

### BRIEF SUMMARY OF THE INVENTION

The present invention solves this need and other problems in the field of locks for panic exit doors by providing, in a preferred form, a lock including a latch movable between an extended, locking position not allowing opening of a door and a retracted, unlocking position allowing opening of the door. A connecting device includes a first end and a second end. The second end of the connecting device is operably coupled to the latch, so that movement of the connecting device in a vertical direction causes movement of the latch between the extended, locking position and the retracted, unlocking position. A base is adapted to be fixed to a side of the door, and a slide is slideably mounted to the base along the vertical direction. The slide includes a base portion and a pivotal section extending from the base portion. An adjusting block is coupled to the first end of the connecting device to move therewith. An adjusting screw is rotatably extended through the pivotal section and threadedly coupled to the adjusting block to engage the adjusting block with the slide so that movement of the slide in the vertical direction causes movement of the adjusting block and the connecting device in the vertical direction to move the latch between the extended, locking position and the retracted, unlocking position. Rotation of the adjusting screw causes movement of the adjusting block and the connecting device in the vertical direction to adjust the extended, locking position of the latch relative to the door.

In the most preferred form, the pivotal section includes a vertical hole extending in the vertical direction and having a stepped portion. The adjusting block includes a screw hole aligned with the vertical hole. The adjusting screw includes a head and a shank extending from a side of the head and having a threaded section with a diameter smaller than that of the head. The head abuts the stepped portion, and the threaded section is extended through and threadedly engaged with the screw hole of the adjusting block. The pivotal section further includes a positioning hole extending perpendicularly to and in communication with the vertical hole. A positioning member is mounted in the positioning hole and movable in an extending direction of the positioning hole between a retaining position pressing against the head and preventing rotation of the adjusting screw and a releasing position disengaged from the head and allowing rotation of the adjusting screw.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a diagrammatic side view of a panic exit door and a lock mounted to the panic exit door and utilizing an adjustable sliding device according to the preferred teachings of the present invention.

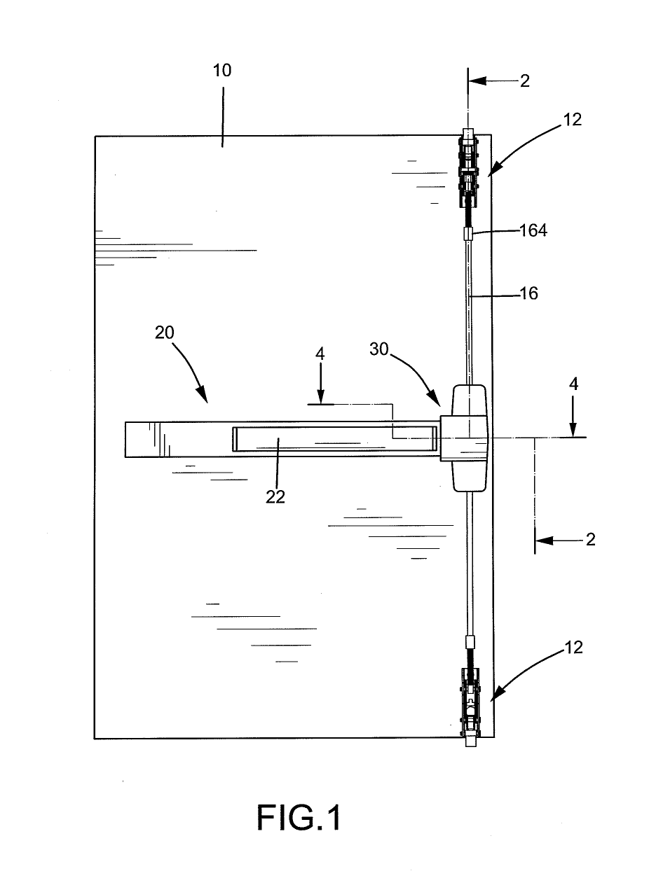

FIG. 2 shows a partial, cross-sectional view of the lock of FIG. 1 according to section line 2-2 of FIG. 1.

FIG. 3 shows a partial, exploded, perspective view of a follower device of the panic device of FIG. 1.

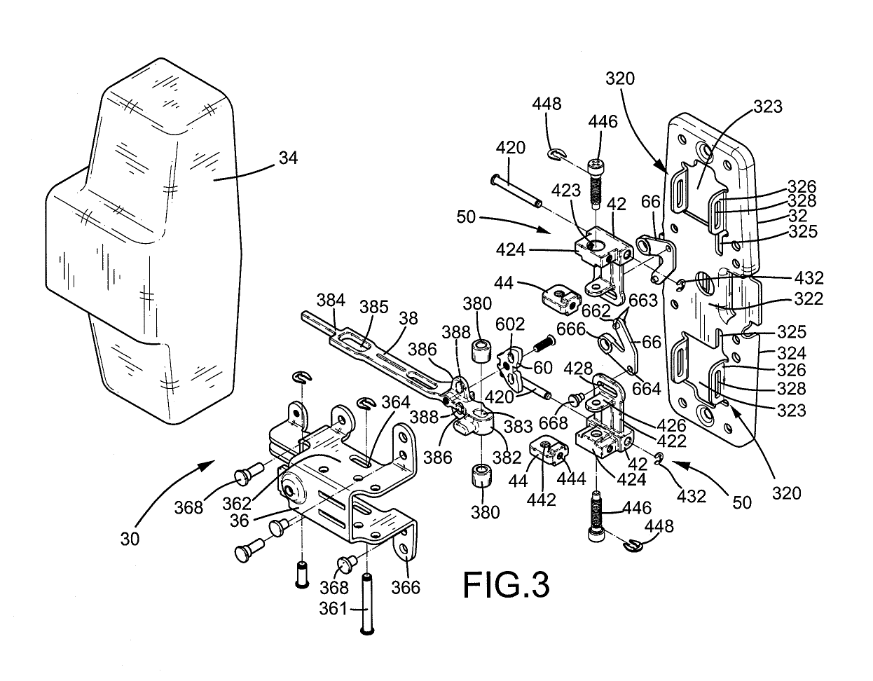

FIG. 4 shows a partial, cross-sectional view of the lock of FIG. 1 according to section line 4-4 of FIG. 1.

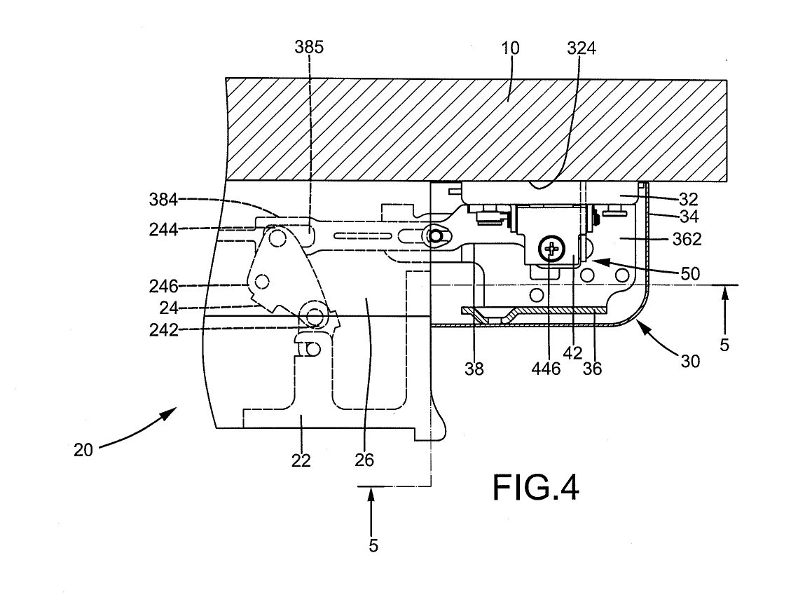

FIG. 5 shows a partial, cross-sectional view of the lock of FIG. 1 according to section line 5-5 of FIG. 4.

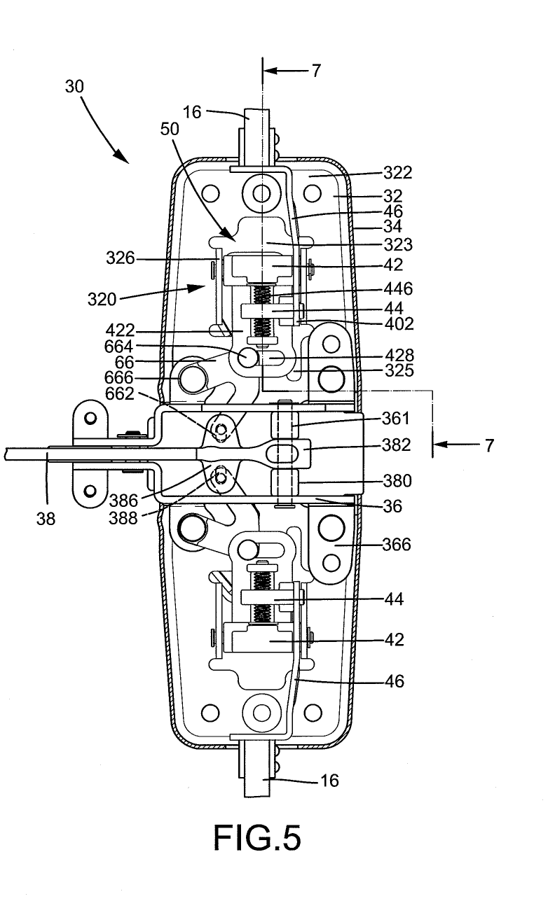

FIG. 6 shows a partial, exploded, perspective view of the follower device of FIG. 3, with a portion of the follower device assembled.

FIG. 7 shows a partial, cross-sectional view of the lock of FIG. 7 according to section line 7-7 of FIG. 5.

FIG. 8 shows a partial, cross-sectional view of the lock of FIG. 1 according to section line 8-8 of FIG. 7.

FIG. 9 shows a partial, cross-sectional view of the panic device of FIG. 1 with a linking rod moved to pivot two links for unlatching purposes.

FIG. 10 shows a partial, cross-sectional view of the lock of FIG. 1 according to section line 2-2 of FIG.1 with the top latch retracted.

FIG. 11 shows a partial, cross-sectional view of the lock of FIG. 1 according to section line 2-2 of FIG. 1 with the top latch in an extended position insufficient for locking.

FIG. 12 shows a partial, exploded, perspective view of a door and a lock utilizing concealed type latches and the adjustable sliding device according to the preferred teachings of the present invention.

FIG. 13 shows a partial, cross-sectional view of the door and the lock of FIG. 12.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “upper”, “lower”, “front”, “rear”, “inner”, “end”, “portion”, “section”, “longitudinal”, “horizontal”, “vertical”, “annular”, “spacing”, “length”, “width”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

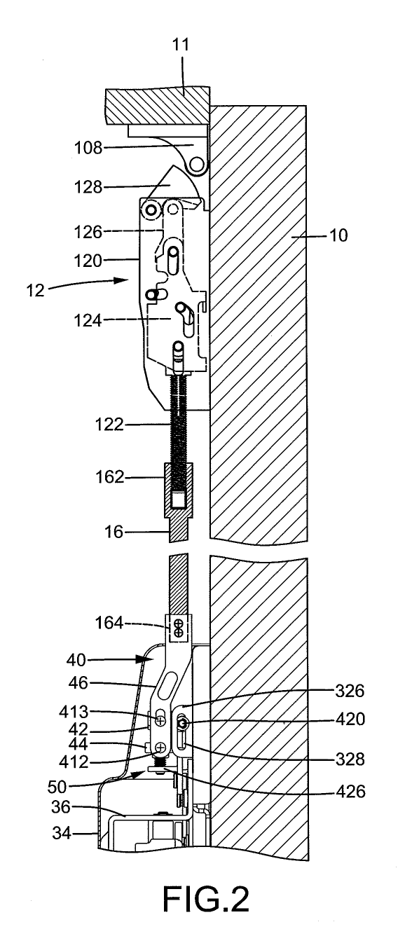

An adjustable sliding device according to the preferred teachings of the present invention is shown in the drawings and generally designated 50. Sliding device 50 is generally utilized with a panic device or lock mounted to a panic exit door 10. According to the preferred form shown, the lock mounted to door 10 includes an operative device 20, a follower device 30 operably connected to operative device 20, top and bottom latch devices 12 operably connected to follower device 30, two connecting devices 40, and sliding device 50 according to the preferred teachings of the present invention. Operative device 20 and follower device 30 are mounted to an inner side of door 10. Door 10 includes a stop 108 on each of a top side and a bottom side of a door frame 11 (FIG. 2).

According to the preferred form shown, each of top and bottom latch devices 12 includes a body 120, a latch 128 pivotably connected to body 120, a follower 124 slideably mounted in body 120 in a vertical direction, and a linking member 126 having a first end coupled to follower 124 and a second end coupled to latch 128. Follower 124 is coupled to a screw rod 122 that can be moved to move latch 128 between an extended, locking position and a retracted, unlocking position.

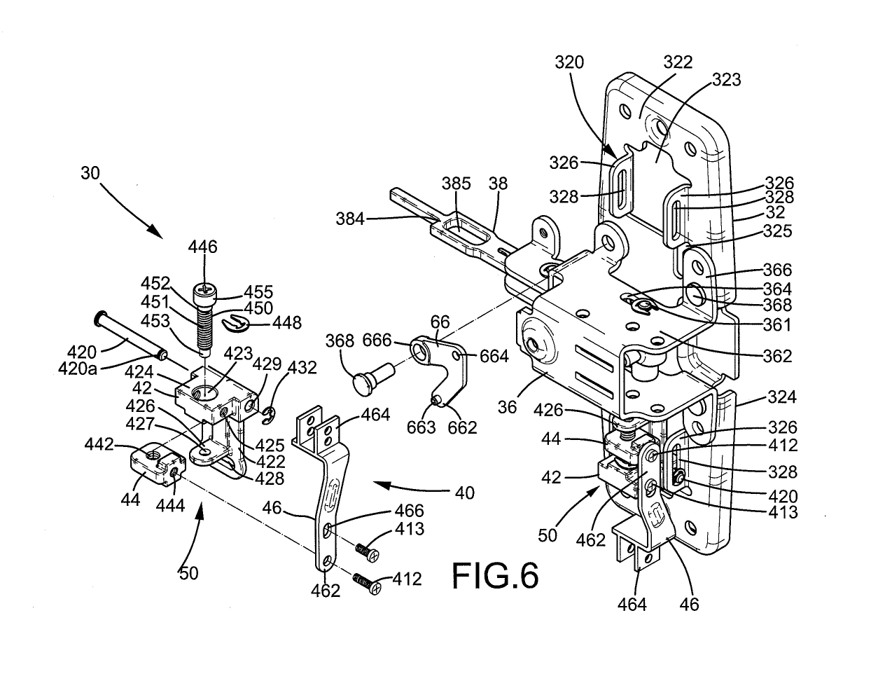

According to the preferred form shown, each connecting device 40 is mounted between follower device 30 and one of latch devices 12. Each connecting device 40 includes a connecting member 46 having first and second ends 462 and 464 and a connecting rod 16. An elongated hole 466 (FIG. 6) is defined in connecting member 46 and adjacent to first end 462. An upper end 162 of each connecting rod 16 is threadedly coupled to screw rod 122 of one of latches 12. A lower end 164 of each connecting rod 16 is coupled to second end 464 of one of connecting members 46. First end 466 of each connecting member 46 is coupled to follower device 30, such that movement of follower device 30 causes movement of screw rods 122 in a vertical direction, which in turn, causes movement of latches 128 between the extended, locking positions and the retracted, unlocking positions. It can be appreciated that connecting devices 40 can be of any desired form as conventional including but not limited to of a commercially available type.

According to the preferred form shown, follower device 30 includes a base 32 fixed to the inner side of door 10 by fasteners such as screws, bolts, or the like. Specifically, base 32 includes a first side 322 and a second side 324 abutting the inner side of door 10. Base 32 further include upper and lower slots 323 spaced in the vertical direction. Parallel, spaced first and second tabs 326 are formed on two sides of upper slots 323 and include aligned vertical tracks 328 extending in the vertical direction and forming an upper guiding mechanism 320. Parallel, spaced third and fourth tabs 326 are formed on two sides of lower slots 323 and include aligned vertical tracks 328 extending in the vertical direction and forming a lower guiding mechanism 320. A sliding slot 325 extends from an edge of each of upper and lower slots 323 in the vertical direction.

According to the preferred form shown, follower device 30 further includes a bracket 36 in the most preferred form shown as a substantially U-shaped structure having parallel, spaced first and second sidewalls 362 spaced in the vertical direction. Bracket 36 further includes an interconnecting wall 363 interconnected between first and second sidewalls 362. Each of first and second sidewalls 362 has a plurality of engaging portions 366. Fasteners 368 are extended through engaging portions 366 to fix bracket 36 to base 32. First and second sidewalls 362 further include aligned limiting slots 364.

According to the preferred form shown, a linking rod 38 is mounted between and spaced from first and second sidewalls 362 of bracket 36 in the vertical direction. Linking rod 38 includes front and rear ends 382 and 384 spaced in a longitudinal axis thereof perpendicular to the vertical direction. Front end 382 of linking rod 38 includes a slot 383. A limiting pin 361 is slideably extended through slots 364 of bracket 36 and slot 383 of linking rod 38. An upper limiting block 380 is mounted in a spacing between an upper face of front end 382 of linking rod 38 and first sidewall 362 of bracket 36, and a lower limiting block 380 is mounted in a spacing between a lower face of front end 382 of linking rod 38 and second sidewall 362 of bracket 36. Each of upper and lower blocks 380 have a length in the vertical direction equal to the spacing between linking rod 38 and sidewall 362 to assist in stable movement of linking rod 38 along the longitudinal axis between first and second sidewalls 362 of bracket 36. Upper and lower wings 386 are formed on linking rod 38 adjacent front end 382. Each of upper and lower wings 386 has a sliding groove 388 extending in the vertical direction. Linking rod 38 further includes a slot 385 adjacent to rear end 384.

According to the preferred form shown, follower device 30 further includes a plate 60 fixed to linking rod 38 and two substantially V-shaped links 66. Plate 60 includes upper and lower grooves 602 aligned with sliding grooves 388 of wings 386. Each link 66 has a first end 662, a second end 666 pivotably connected to one of engaging portions 366 of bracket 36, and an intermediate portion 664. First end 662 of each link 66 includes first and second pegs 663 on two faces thereof. First peg 663 of each link 66 is slideably received in sliding groove 388 of one of wings 386. Second peg 663 of each link 66 is slideably received in one of upper and lower grooves 602 of plate 60. Follower device 30 further includes two pins 668 each extending through intermediate portion 664 of one of links 66 and slideably extending through groove 428 of one of upper and lower slides 42. Thus, intermediate portion 664 of each link 66 is pivotable relative to one of upper and lower slides 42 and slideable along groove 428 of one of upper and lower slides 42. When linking rod 38 is moved along the longitudinal axis, links 66 are rotated to move upper and lower slides 42 toward or away from each other in the vertical direction, moving top and bottom latch devices 12 toward or away from each other in the vertical direction.

According to the preferred form shown, operative device 20 includes a housing 26 fixed to the inner side of door 10 and an operative member 22 in the most preferred form shown as a press bar pivotably coupled to housing 26. A rocker 24 is mounted in housing 26 and includes a first corner 242 pivotably connected to operative member 22, a second corner 244 pivotably coupled with slot 385 of linking rod 38, and a third corner 246 pivotably connected to housing 26. When operative member 22 is operated (e.g., pressed), rocker 24 pivots to move linking rod 38 in an unlatching direction along the longitudinal axis. Operative device 20 for actuating linking rod 38 can be of any desired form as conventional including but not limited to of a commercially available type.

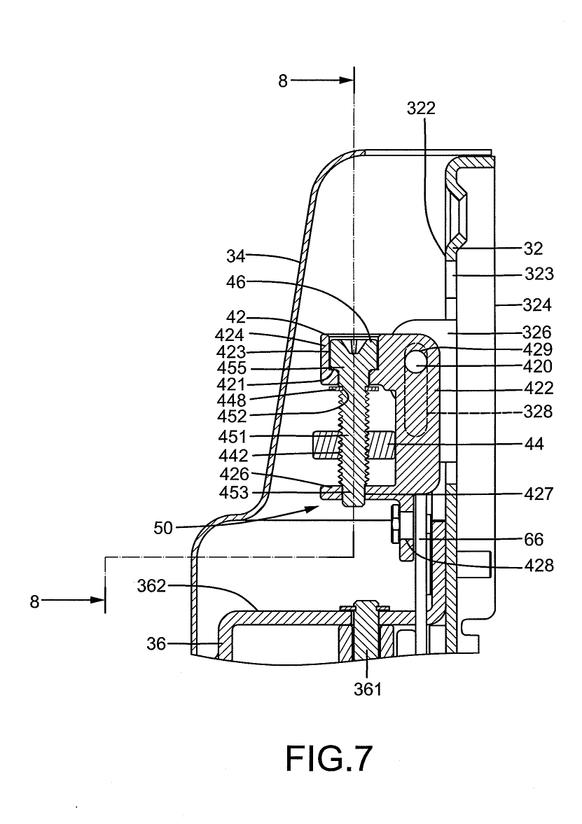

According to the preferred form shown, sliding device 50 according to the preferred teachings of the present invention is mounted to guiding mechanisms 320 on base 32. Sliding device 50 includes an upper slide 42 slideably mounted between first and second tabs 326 in the vertical direction, and a lower slide 42 slideably mounted between third and fourth tabs 326 in the vertical direction. Each of upper and lower slides 42 includes a base portion 422 extending in the vertical direction, a support 426 extending perpendicularly from a side of base portion 422, a pivotal section 424 extending perpendicularly from the side of base portion 422 and spaced from support 426 in the vertical direction, and a groove 428 formed in base portion 422 and extending in a horizontal direction perpendicular to the vertical direction and spaced from support 426 in the vertical direction. Groove 428 has a spacing to pivotal section 424 larger than support 426. Pivotal section 424 includes a vertical hole 423 having a stepped portion 421 (FIG. 7). Pivotal section 424 further includes a positioning hole 425 in the most preferred form shown as a screw hole extending perpendicularly to and in communication with vertical hole 423. Base 422 further includes an axle hole 429 parallel to and spaced from positioning hole 425 in a direction perpendicular to the vertical direction. Support 426 includes a receiving hole 427 aligned with vertical hole 423. An upper axle 420 is extended through axle hole 429 of upper slide 42 and slideably extended through vertical tracks 328 of first and second tabs 326, allowing upper slide 42 to slide between first and second tabs 326 in the vertical direction. A lower axle 420 is extended through axle hole 429 of lower slide 42 and slideably extended through vertical tracks 328 of third and fourth tabs 326, allowing lower slide 42 to slide between third and fourth tabs 326 in the vertical direction, with grooves 428 adjacent to each other. A retainer 432 in the most preferred form shown as a C-clip is mounted in an annular groove 420a in a distal end of each of upper and lower axles 420, preventing upper and lower axles 420 from disengaging from upper and lower slides 42.

According to the preferred form shown, an adjusting block 44 is mounted on each of upper and lower slides 42. Each adjusting block 44 includes a screw hole 442 extending in the vertical direction and a positioning hole 444 in the most preferred form shown as a screw hole extending in a direction perpendicular to the vertical direction.

According to the preferred form shown, sliding device 50 further includes two adjusting screws 446 each including a head 455 and a shank 450 extending from side of head 455 and having a diameter smaller than that of head 455. Shank 450 has a threaded section 451 and an annular groove 452 formed between head 455 and threaded section 451. Shank 450 further includes a pivotal portion 453 in the most preferred form shown formed at the distal end distant to head 455. Shank 450 of each adjusting screw 446 extends through vertical hole 423 of pivotal section 424 of one of upper and lower slides 42 and through screw hole 442 of one of adjusting blocks 44. Head 455 of each adjusting screw 446 abuts stepped portion 421 of one of upper and lower slides 42. Each adjusting screw 446 is retained in place by a retainer 448 in the most preferred form shown as a C-clip engaged in annular groove 452, allowing free rotation of adjusting screw 446 and preventing adjusting screw 446 from disengaging from pivotal section 424. Note that a face of each adjusting block 44 presses against the side of one of upper and lower slides 42. Thus, when adjusting screws 446 are rotated, adjusting blocks 44 move along adjusting screws 446 in the vertical direction rather than rotate together with adjusting screws 446. Note that pivotal portion 453 of each adjusting screw 446 is rotatably received in receiving hole 427 of support 426 of one of upper and lower slides 42, assuring stable rotation of adjusting screw 446.

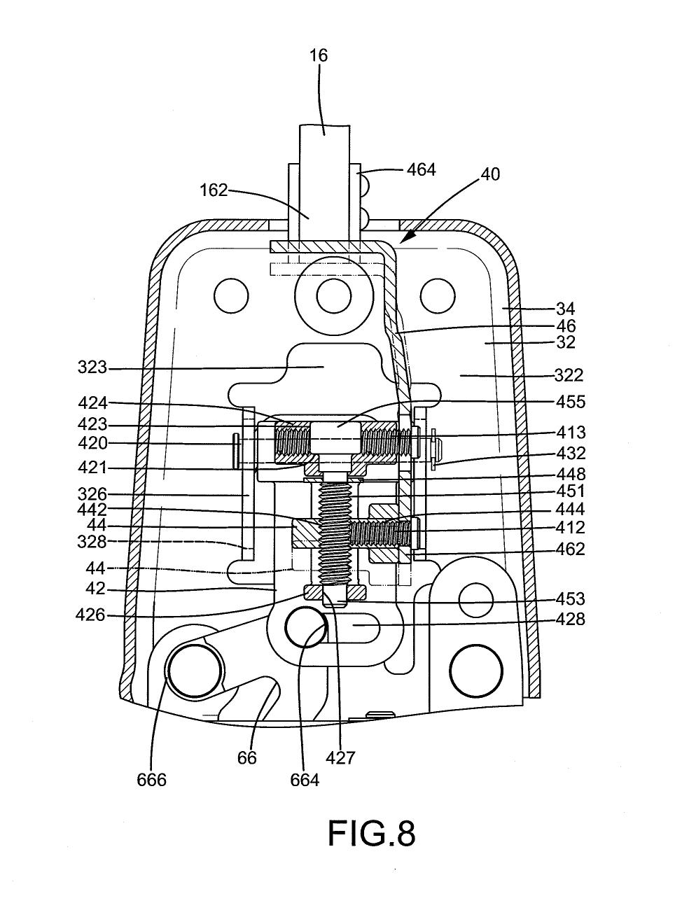

First end 462 of each connecting member 46 is fixed to one of adjusting blocks 44 by extending a fastener 412 through first end 462 of connecting member 46 into positioning hole 444 of adjusting block 44. Thus, movement of adjusting blocks 44 in the vertical direction causes movement of connecting members 46 in the vertical direction. Furthermore, a positioning member 413 in the most preferred form shown as a screw is extended through elongated slot 466 of each connecting member 46 into positioning hole 425 of one of upper and lower sides 42. Each positioning member 413 is movable in an extending direction of positioning hole 425 between a retaining position pressing against head 455 of one of adjusting screws 446 and preventing rotation of adjusting screw 446 (FIG. 8) and a releasing position disengaged from head 455 and allowing rotation of adjusting screw 446.

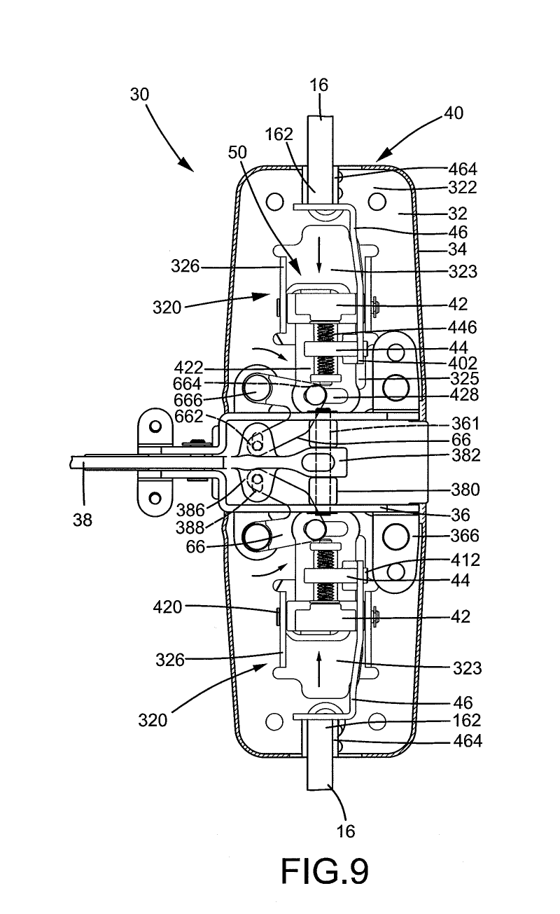

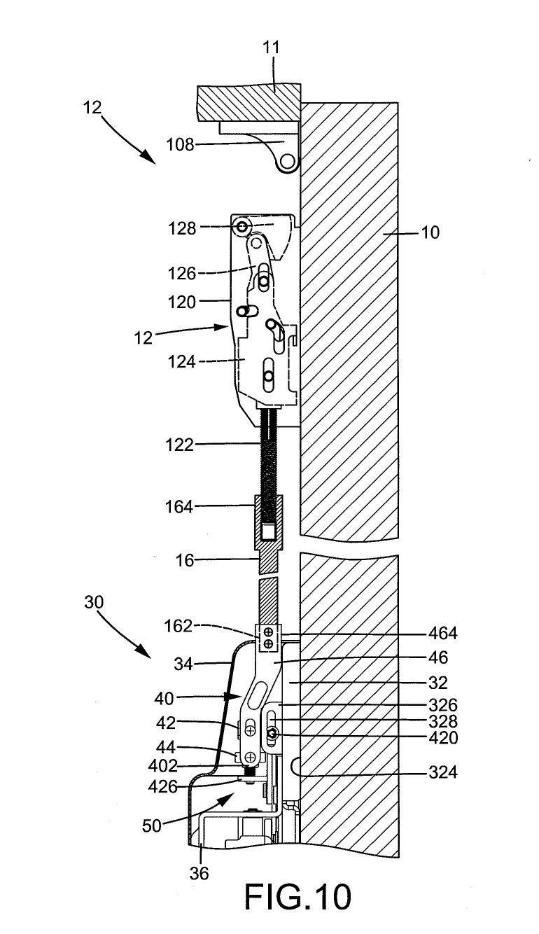

In operation, when linking rod 38 is moved in the unlatching direction such as due to pressing of operative member 22, links 66 are pivoted in directions indicated by arrows shown in FIG. 9 to move upper and lower slides 42 toward each other. Adjusting blocks 44 are moved toward each other to move connecting devices 40 toward each other. Latches 128 are, thus, moved to the retracted, unlocking positions not stopped by stops 108, allowing opening of door 10 (FIG. 10). When operative member 22 is released, linking rod 30 is moved in a latching direction opposite to the latching direction to return latches 128 to the extended, locking positions not allowing opening of door 10 (FIG. 2).

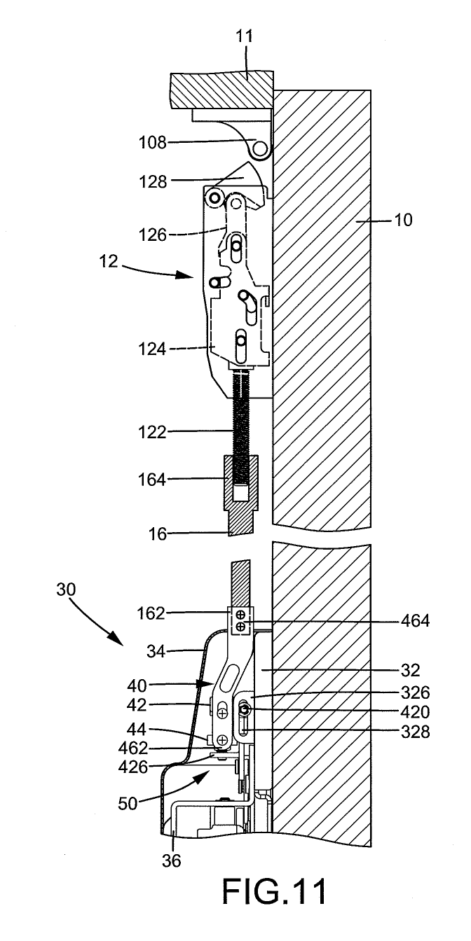

After installation of latches 12 onto door 10, the spacing from an end of each screw rod 122 to one of adjusting blocks 44 is fixed. After coupling with connecting rods 16, the exposed extents of latches 128 are dependent upon the overall lengths of connecting devices 40. In a case that the overall length of each connecting device 40 is smaller than the spacing, the exposed extent of latch 128 will be insufficient to provide the required locking functions (FIG. 11). Adjustment of positions of latches 128 can be achieved by rotating connecting rods 16 to change the coupling length between the connecting rod 16 and screw rod 122. However, rotation of connecting rod 16 is impossible after first ends 462 of connecting members 46 are coupled with adjusting blocks 48.

In this case, adjustment of the exposed extents of latches 128 is still possible by sliding device 50 according to the preferred teachings of the present invention. Specifically, positioning members 413 are loosened (moved to the releasing positions), and adjusting screws 446 are rotated to move adjusting blocks 44 in the vertical direction. This causes movement of connecting members 46 in the vertical direction to change the exposed extents of latches 128. After latches 128 are adjusted to the desired positions, positioning members 446 are moved to the retaining positions pressing against heads 455 of adjusting screws 446 and preventing rotation of adjusting screws 446. Thus, sliding device 50 according to the preferred teachings of the present invention allows easy adjustment of extended, locking positions of latches 128 relative to door 10 in an easier manner without the need of detaching components of the lock, saving the time for installation.

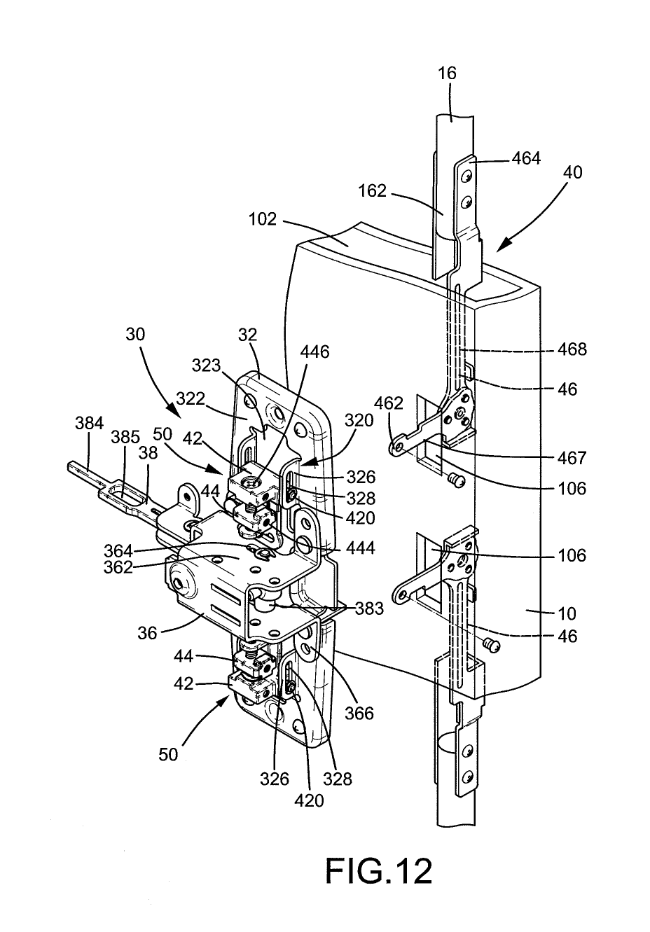

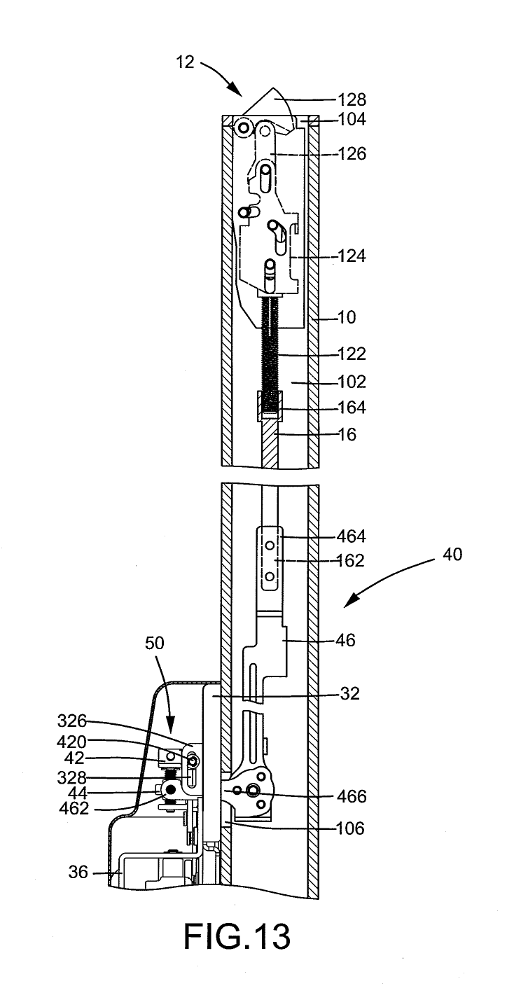

Sliding device 50 according to the preferred teachings of the present invention can be utilized with latches 12 of concealed type. In this case, door 10 is hollow and includes an interior space 102 receiving latches 12 (FIGS. 12 and 13). Door 10 further includes an end opening 104 in each of a top edge and a bottom edge thereof. Door 10 further includes two side openings 106 in the inner side. End openings 104 and side openings 106 are in communication with interior space 102. According to the preferred form shown, each of top and bottom latch devices 12 are mounted into interior space 102 via one of end openings 104. Each connecting member 46 includes a vertical section 468 having an end 464 coupled to first end 162 of one of connecting rods 16. Each connecting member 46 further includes a horizontal section 467 having an end coupled to the other end of vertical section 468. The other end of horizontal section 467 forms first end 462 of connecting member 46. Horizontal section 467 of each connecting member 46 is extended through one of side openings 106 of door 10 and one of slots 323 of base 32 and coupled to one of adjusting blocks 44. Thus, movement of adjusting blocks 44 in the vertical direction causes movement of connecting members 46 and connecting rods 16 in the vertical direction, moving latches 128 between the extended, locking positions and the retracted, unlocking positions. Note that sliding slots 325 allow vertical movement of horizontal sections 467 of connecting members 46. Rotation of connecting rods 16 for adjusting positions of latches 128 will be interfered by connecting devices 40, for horizontal sections 467 of connecting members 46 are longer than a width of interior space 102 of door 10. However, by provision of sliding device 50 according to the preferred teachings of the present invention, adjustment of positions of latches 128 can be easily accomplished by moving adjusting blocks 44 through simple rotation of adjusting screws 446.

Now that the basic teachings of the present invention have been explained, many extensions and variations will be obvious to one having ordinary skill in the art. For example, sliding device 50 according to the preferred teachings of the present invention can be utilized with follower device 30 of any desired form as conventional including but not limited to of a commercially available type. Furthermore, sliding device 50 according to the preferred teachings of the present invention can be utilized with top or bottom latch device 12 of any desired form as conventional including but not limited to of a commercially available type. One of latch devices 12 and one of connecting devices 40 can be omitted, if desired.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A lock for a door comprising, in combination:
a latch (128) movable between an extended, locking position not allowing opening of the door and a retracted, unlocking position allowing opening of the door;
a connecting device (40) including a first end (462) and a second end (464), with the second end (464) of the connecting device (46) being operably coupled to the latch (128), so that movement of the connecting device (40) in a vertical direction causes movement of the latch (128) between the extended, locking position and the retracted, unlocking position;
a base (32) adapted to be fixed to a side of the door;
a slide (42) slideably mounted to the base (32) along the vertical direction, with the slide (42) including a base portion (422) and a pivotal section (424) extending from the base portion (422);
an adjusting block (44) coupled to the first end (462) of the connecting device (40) to move therewith; and
an adjusting screw (446) rotatably extending through the pivotal section (424) and threadedly coupled to the adjusting block (44) to engage the adjusting block (44) with the slide (42) so that movement of the slide (42) in the vertical direction causes movement of the adjusting block (44) and the connecting device (40) in the vertical direction to move the latch (128) between the extended, locking position and the retracted, unlocking position, with rotation of the adjusting screw (446) causes movement of the adjusting block (44) and the connecting device (40) in the vertical direction to adjust the extended, locking position of the latch (128) relative to the door.

2. The lock as claimed in claim 1, with the pivotal section (424) including a vertical hole (423) extending in the vertical direction, with the vertical hole (423) having a stepped portion (421), with the adjusting block (44) including a screw hole (442) aligned with the vertical hole (423), with the adjusting screw (446) including a head (455) and a shank (450) extending from a side of the head (455) and having a threaded section (451) with a diameter smaller than that of the head (455), with the head (455) abutting the stepped portion (421), and with the threaded section (451) being extended through and threadedly engaged with the screw hole (442) of the adjusting block (44),

3. The lock as claimed in claim 2, with the shank (450) further including an annular groove (452) between the threaded section (451) and the head (455), with the adjusting block (44) having a face pressing against the slide (42), with a retainer (448) being mounted in the annular groove (452) to prevent the adjusting screw (446) from disengaging from the pivotal section (424) and to allow free rotation of the adjusting screw (44) without movement in the vertical direction.

4. The lock as claimed in claim 2, with the pivotal section (424) further including a positioning hole (425) extending perpendicularly to and in communication with the vertical hole (423), with the lock further comprising, in combination: a positioning member (413) mounted in the positioning hole (425) and movable in an extending direction of the positioning hole (425) between a retaining position pressing against the head (455) and preventing rotation of the adjusting screw (446) and a releasing position disengaged from the head (455) and allowing rotation of the adjusting screw (446).

5. The lock as claimed in claim 2, with the slide (42) further including a support (426) extending from the base portion (422) and parallel to and spaced from the pivotal section (424) in the vertical direction, with the support (426) including a receiving hole (427) aligned with the vertical hole (423), with the shank (450) further including a pivotal portion (453) rotatably received in the receiving hole (427).

6. The lock as claimed in claim 2, with the base (32) including parallel, spaced first and second tabs (326) extending therefrom in a direction perpendicular to the vertical direction, with the first and second tabs (326) including aligned vertical tracks (328) extending in the vertical direction, with the base portion (422) of the slide (42) including an axle hole (429) extending in a direction perpendicular to the vertical direction, with the lock further comprising, in combination: an axle (420) slideably extending through the vertical tracks (328) and extending through the axle hole (429) of the slide (42), allowing sliding movement of the slide (42) between the first and second tabs (326) in the vertical direction.

7. The lock as claimed in claim 6, with the base (32) further including a slot (323) having first and second sides, with the base (32) further including a sliding slot (325) extending from an edge of the slot (323) in the vertical direction, with the first and second tabs (326) extending from the first and second sides of the slot (323), with the connecting device (40) including a vertical section (468) having the second end (464) operably coupled to the latch (128), with the connecting device (40) further including a horizontal section (467) having the first end (462) coupled to the adjusting block (44), with the horizontal section (467) extending through the slot (323) and slideably received in the sliding slot (325).
